(19) United States
(12) Patent Application Publication
(10) Pub. No.: US 2010/0223861 A1
(43) Pub. Date: Sep. 9, 2010

(54) APPARATUS TO DETER BIRDS FROM CRASHING INTO WINDOWS

(76) Inventor: David R. Warwick, Santa Rosa, CA (US)

Correspondence Address: EDWARD S. SHERMAN, ESQ., 3554 ROUND BARN BLVD., SUITE 303, SANTA ROSA, CA, 95403, US

(21) Appl. No.: 12/717,006

(22) Filed: Mar. 3, 2010

Related U.S. Application Data
(60) Provisional application No. 61/209,574, filed on Mar. 9, 2009.

(51) Int. Cl. E04B 1/72; A01K 45/00

(52) U.S. Cl. 52/101; 119/713; 119/174

(57) ABSTRACT

An apparatus to prevent birds from crashing into glass is affixed over the exterior of a window glass. It comprises two parallel rods of equal length between which are affixed a plurality of fine strings. The strings are perpendicular to the rods and parallel to one another. Either of the rods, which are identical, is affixed horizontally to a surface above the glass window. The second rod is positioned horizontally beneath the glass area so that the said strings run straight and parallel over the glass. Thus, by placing strings at a distance in front of the glass so as to allow their reflections to be noticed by approaching birds, which reflections will be seen by the birds as converging and separating and perceived as motion that will warn them off. The second horizontal rod can be affixed to the surface directly below the glass, or alternatively, it may simply hang by its own weight. The apparatus is adjustable to fit windows of varying heights by means of rolling one rod towards the other. It is adaptable to windows of varying widths by means of joining two or more apparatuses side by side. When uninstalled, the apparatus rolls into a small unit for storage and shipping.

### CROSS REFERENCE TO RELATED APPLICATIONS

The present application claims priority to the U.S. Provisional Patent application having Ser. No. 61/209,574 titled “APPARATUS TO DETER BIRDS FROM CRASHING INTO WINDOWS”, filed on Mar. 9, 2009, which is incorporated herein by reference.

### BACKGROUND OF INVENTION

The present invention relates to an apparatus for preventing birds form crashing into windows.

Millions of birds die each year when they accidentally fly into glass windows.

It is believed this occurs because reflected images from glass impart a false impression to birds that they are flying safely into open sky or clearings. Bird deaths and injuries are a particular problem where birds congregate at bird feeders located near glass windows and doors, and this is a source of anguish for the bird lovers who feed them.

Several devices are designed to prevent such bird collisions. One device employs various shaped decals that adhere to window glass and that are intended to signal birds of the presence of glass. A particular type of decal reflects UV light, which birds can see. Yet another type of decal contains a spider-web design, based on the theory that birds avoid spider webs. But, the use of window decals, which typically measure less than a foot in diameter, is largely ineffective—that is, unless enough are used to cover most of the window area: But, this is generally unacceptable because it blocks one's view through the window. Moreover, the use of decals to can be harmful to certain types of coated glass (e.g., Low-E). Yet another method would place full screens or netting in front of glass. Again, these methods are objectionable in that they tend to block one's view, particularly of birds, from inside.

Wires or strings are also used in various ways to obstruct birds, as disclosed in many of the following documents, which are incorporated herein by reference:

U.S. Pat. No. 5,092,088, issued June 1990 to Way;

U.S. Pat. No. 5,713,160 issued February 1998 to Herron;

U.S. Pat. No. 6,418,674 issued July 2002 to Delraedt;

U.S. Pat. No. 6,918,214B2 issued July 2005 Sabine;

EP 1319335 issued December 2006 to Mayerhuber; and

JP 08308461 issued November 1996 to Okada

Daniel Klem, Jr. “Preventing Bird-Window Collisions,” The Wilson Journal of Ornithology, 121(2):314-321,2009. (This study tested the effectiveness of window decals and found that they are ineffective unless spaced about 1½″ apart covering an entire window.)

The patents of Way, Herron, Delraedt and Sabine, cited above, employ various configurations of wire. However, the common function of this group and similar patents is to prevent birds from landing, perching or roosting on surfaces such as lighting poles, electric lines, boat railings, etc.—which is distinct from deterring birds from flying in a certain flight path.

Wire or string also used to deter birds from flying in certain flight paths. Even lines etched or embedded in glass tend to prevent birds from flying into it. (See Mayerhuber, cited above, for a discussion of the aversion birds have for even very fine lines.) Stings of wire have proven effective in blocking birds from flying through open-air restaurants, for example.

A number of patents employ wires or strings to impede bird flight. Many involve stringing wires over roof tops, expanses of water, building ledges, and balconies. However, installing one at time, even if over a relatively small glass windows, can be time consuming and tedious, and any permanent mountings might be troublesome to remove and replace for window cleaning Okada, cited above, came up with the idea of using a wire-strung frame that, similar to the apparatus that is the subject of this application, could be placed over a window area. Okada merely employs wires as physical barriers that can be mounted anywhere: Birds either collide with the Okada wires or see them in advance and avoid them. However, each such frame has to be constructed for particular size window. From the user's point of view, this requires making a separate frame for each window, or having them custom made. From a marketing point of view, this requires custom fabrication or stocking of multiple sizes frames.

It is therefore a first object of the present invention to provide an improved means to prevent birds from flying into glass windows by placing strings in their flight path.

Another object of the invention is to protect an entire window area without significantly obstructing the outward view through a window.

A still further object of the invention is to provide an apparatus that can be immediately, quickly and easily installed by an unskilled person.

Yet another object of the invention is provide facile adjustability to varying heights and widths of windows so as to improve the quality and durability of the installation no matter what the skill level of the installer.

A still further object of the invention is simplicity, compactness and low cost, as well as minimizing the likelihood of any injury to birds from the installation.

### SUMMARY OF INVENTION

In the present invention, the first object is achieved by providing an apparatus for repelling birds from windows, the apparatus comprising: a first elongated shaft, a second elongated shaft disposed parallel and below said first elongated shaft, each of the first and second elongated shafts having two ends disposed at the opposite side of the principal axis thereof, at least a first pair of two laterally disposed brackets having a shaft receiving end and a wall mounting end, wherein each of the brackets in said pair are disposed for supporting at least one of said first and second elongated shafts on the shaft receiving end near the opposing ends thereof with each bracket being disposed perpendicular the principal axis of said elongated shaft supported thereon, a plurality of flexible wires connected to and spaced apart along each of the first and second elongated shafts in which each of the wires in said plurality is capable of extending outward from the first elongated shaft to the second elongated shaft to form an array of parallel spaced wires, wherein the brackets have a length perpendicular to the elongated shaft supported therein of at least about 1 inches to provide a capability for spacing the array of parallel spaced wires away from a window when the brackets are mounted at the side of a window so that said elongated shafts are disposed parallel to the side of the window.

A second aspect of the invention is characterized by an apparatus for repelling birds from windows, the apparatus comprising a first elongated shaft, a second elongated shaft disposed parallel and below said first elongated shaft, each of the first and second elongated shafts having two ends disposed at the opposite side of the principal axis thereof, at least a first pair of two brackets having a shaft receiving end and a wall mounting end, wherein each of brackets in said pair are disposed for supporting at least one of said first and elongated shafts on the shaft receiving end near the opposing ends thereof with each bracket being disposed perpendicular the principal axis of said elongated shaft supported thereon, a plurality of wires connected to and spaced apart along each of the first and second elongated shafts in which each of the wires in said plurality extends outward from the first elongated shaft to the second elongated shaft to form a an array of parallel spaced apart wires, wherein the plurality of wires that connect to said first and second elongated shafts are wound around at least one of said first and second shaft perpendicular to the principal axis thereof.

Another aspect of the invention is characterized by a building comprising a least one lateral wall having an aperture therein, a transparent window disposed to cover said aperture in the lateral wall, a first elongated shaft, a second elongated shaft disposed parallel and below said first elongated shaft, each of said first and second elongated shafts having two ends disposed at the opposite side of the principal axis thereof, at least a first pair of two laterally disposed brackets having a shaft receiving end and a wall mounting end, wherein each of the brackets in said pair are disposed for supporting said first an elongated shafts on the shaft receiving end near the opposing ends thereof with each bracket being disposed perpendicular the principal axis of said first elongated shaft, a plurality of wires connected to and spaced apart along each of the first and second elongated shafts in which each of the wires in said plurality extends downward from the said elongated shaft to said second elongated shaft to form a vertical wire array, wherein the upper brackets are mounted at the wall mounting end to the portion of the wall above the aperture therein.

A still further aspect of the invention is characterized by a kit for installing a bird strike protective apparatus over windows, the kit comprising a first elongated shaft, a second elongated shaft, a plurality of wires connected to and spaced apart along each of the first and second elongated shafts in which each of the wires in said plurality is capable of extending outward from the first elongated shaft to the second elongated shaft to form an array of parallel spaced apart wire, wherein the plurality of wires that connect to the first and second elongated shafts are wound around at least one of the first and second shaft perpendicular to the principal axis thereof substantially at the point of attachment thereto so as to permit the spacing apart of the shafts by rotating at least one shaft to uncoil all the wires in said plurality simultaneously.

The above and other objects, effects, features, and advantages of the present invention will become more apparent from the following description of the embodiments thereof taken in conjunction with the accompanying drawings.

### BRIEF DESCRIPTION OF THE DRAWINGS

FIG. 1 is a front elevation of a first embodiment of the invention.

FIG. 2A is a cross-sectional elevation of the first embodiment of the invention installed to protect a window.

FIG. 2B is a front elevation of a portion of the bracket in FIG. 2A.

FIG. 2C is a cross-sectional elevation of a second embodiment of the invention installed to protect a window.

FIG. 2D is a cross-sectional elevation of a third embodiment of the invention installed to protect a window.

FIG. 2E is a cross-sectional elevation of a fourth embodiment of the invention installed to protect a window.

FIG. 3A is a front elevation of another embodiment of the invention.

FIG. 3B is a front cross-sectional elevation showing a portion of a first alternative to the embodiment of FIG. 3A.

FIG. 3B is a front cross-sectional elevation showing a portion of a second alternative to the embodiment of FIG. 3A.

FIG. 3D is a side cross-sectional elevation of the embodiment of the invention installed to protect a window at section line D-D in FIG. 3A.

FIG. 4 is a front perspective view of a portion of the embodiment of FIG. 2A and 2C to illustrate a preferred mounting bracket.

FIG. 5 is a front perspective view of an alternative embodiment to show how the wire can be unraveled from the lower rod, which is optionally then set in the preferred mounting bracket of FIG. 2A.

FIG. 6 is a diagram intended to illustrate principles that favor a birds perception of the strings or wire when flying at the optimally spaced wires.

FIG. 7 is a bar graph illustrating the frequency of bird strikes and the resulting outcomes when the spacing of the wires was increased from one inch to five inches.

### DETAILED DESCRIPTION

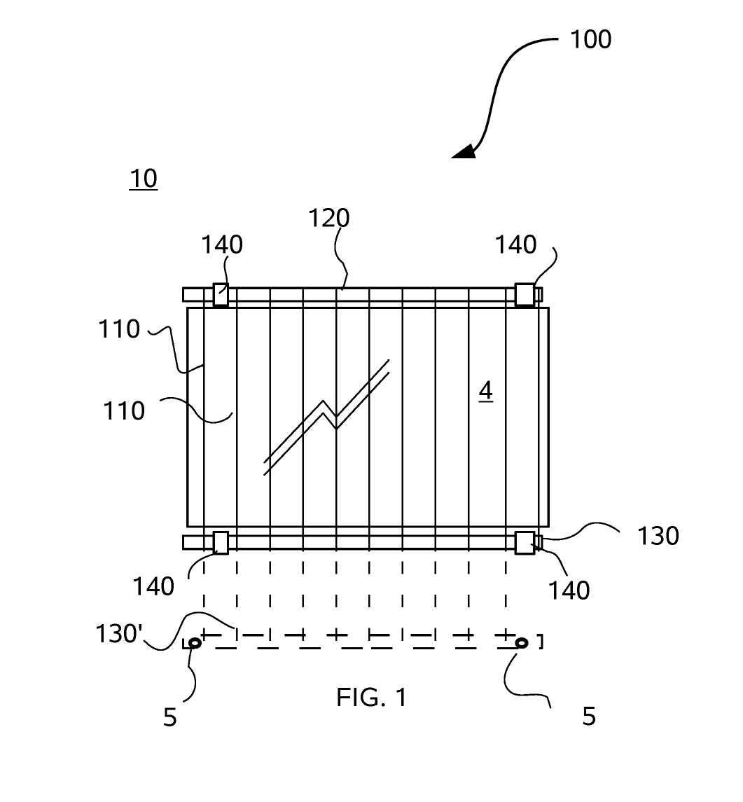

Referring to FIGS. 1 through 7, wherein like reference numerals refer to like components in the various views, there is illustrated therein a new and improved apparatus to deter birds from crashing into windows, generally denominated 100 herein.

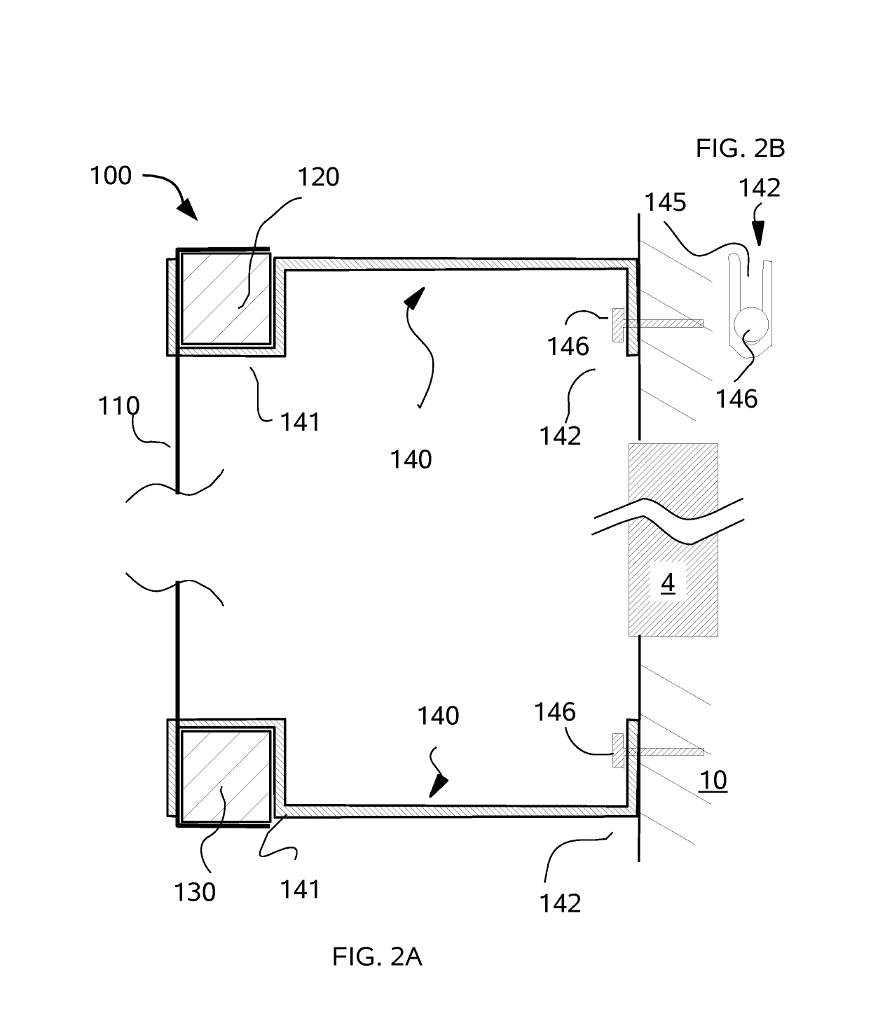

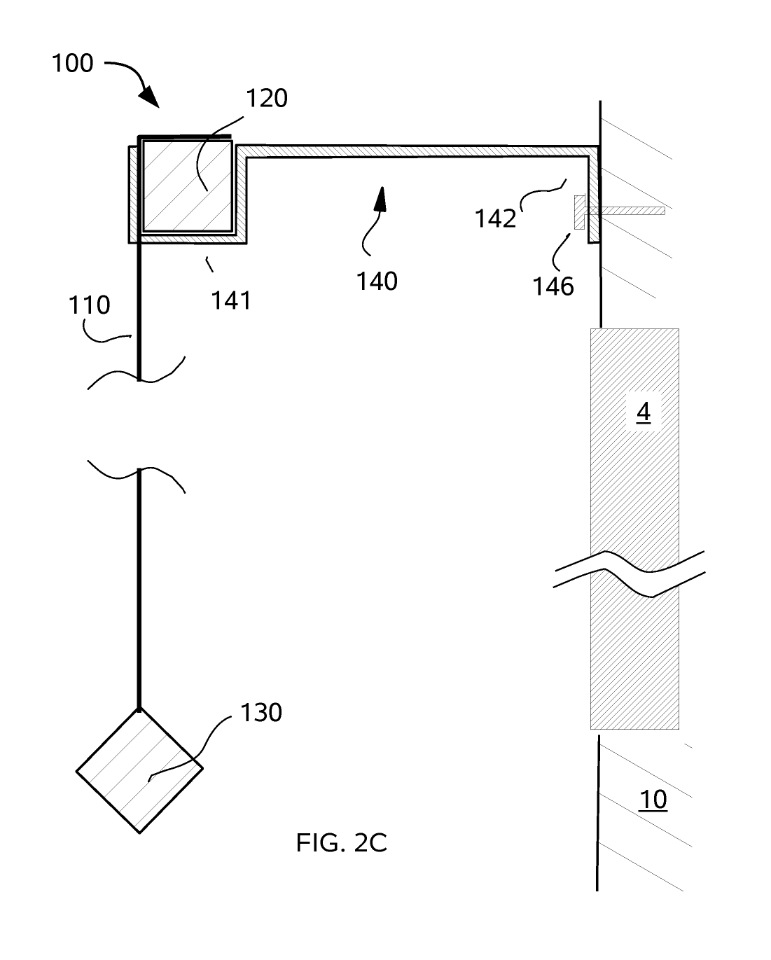

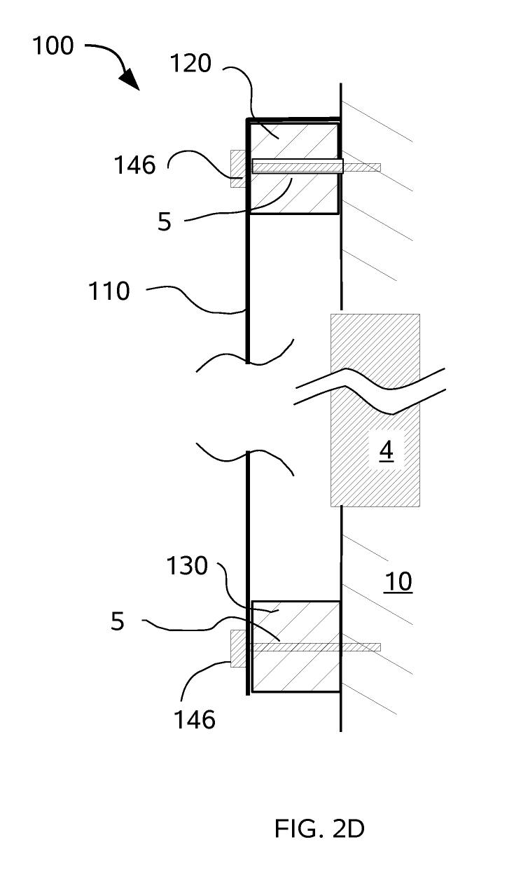

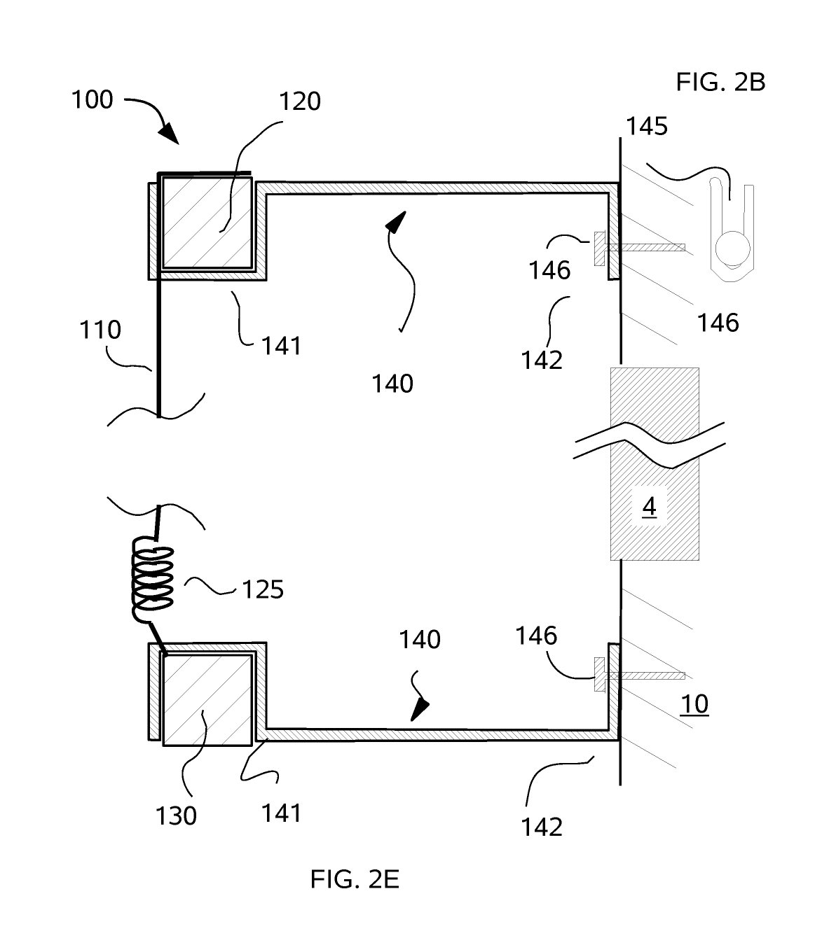

In accordance with the present invention, FIG. 1 illustrates a first embodiment in which a window 4 of a structure 10 is protected by apparatus 100. The bird deterring apparatus 100 of this invention is preferably constructed with an upper rod 120 affixed by a plurality of strings 110 to a lower rod 130 (labeled 130′ in its low position and 130 in a raised position). The strings may comprise wire or line made of any material including but not limited to plastic fishing line. Ideally, such elastic fishing lines or comparable elastic wires are installed to be barely taut and thus easily give way to the slightest pressure. In my experience all the birds that stuck them simply flew away. The birds only appeared to suffer injury or fatalities when they hit the glass 4. The rods 120 & 130 are mounted respectively above and below a glass window 4 on the exterior wall 10 of the building structure, so as to cause the strings 110 to be stretched across the expanse of the window area, which is generally but not necessarily hard glass 4, as windows can also be plastic or laminates of different transparent materials. Thus, in order to control the tension in the strings or wires 110, it is desirable to mount the rods 120 and 130 parallel to each but vertically displaced over the vertical expanse of the window 4, with the principal axis of each rod or shaft 120 or 130 parallel to each other, but spaced away from the plane of the window 4. In the embodiment of FIG. 2D, mounting holes 5 may be provided for using fasteners, such as nails and screws 146 to affix said rods 120 & 130 to a surface, such as the building exterior 10. However, alternate means can be used to affix said rods 120 & 130 to said surface, and include but are not limited to, the use of supports, rests or brackets 140 protruding from at least the surface above the window 4 on which the upper rod 120 hangs.

It is generally preferred to use brackets 140 or comparable structures, which are optionally integrated into the rod or other building structure, to provide an optimal spacing of the wires 110 from the glass 4 to enhance the ability of birds to see the wires and change direction before hitting them. It has been discovered that this optimal distance is preferably more than an inch, but even more preferably greater than about 2 inches and most preferably about 5″.

Generally, for most windows to be protected with the apparatus 100, the width of the window is likely to be at least about 2-3 feet, but more preferably 5-6 feet, and with a wire spacing of about 2-6 inches (i.e. 2 to 6 wires per foot of rod length), from about 4 to about 18 pairs of connecting wires 110, and more for larger windows.

Such brackets 140, as shown in FIG. 2A-C, 4 and 5, generally can be considered to have shaft receiving end 141 and a wall mounting end 142. In the usual installation, at least a pair of brackets 140 are disposed for supporting at least the upper rods or elongated shafts 120 on the shaft receiving end 141 near the opposing ends thereof with each bracket 140 being generally disposed perpendicular to the principal axis of the rod or elongated shaft 120 or 130.

The brackets 140 can have great variability in length or shape but preferably are adapted to accommodate the rods 120 and 130 in a manner that facilitates installation and the adjustment of the length and tension of all the wires 110 simultaneously. According, in a more preferred embodiment, the rods 120 and 130 have a non-circular cross-section and nest in close proximity to surrounding and conforming sides of the shaft receiving end 141, as for example with a square cross-section of the rod 120 and 130 and a matching square opening on the receiving end 141. This prevents rotation of either rod 120 or 130 after the desired quantity of wire has been unreeled or unwrapped from the rods, but pulled taught to the desired tension. If the rod 120 and 130 cannot rotate, then the tension will be set for all the strings or wires 110 simultaneously. It should also be appreciated that the tension in the strings or wire 110 can be adjusted by attaching the strings 110 to at least the upper or lower rod 120 or 130 via springs 125 (as shown in FIG. 2E) rather than directly. In this case it is preferable to leave one rod 120 without springs 125 wind the excess string around or wire 110 are this rod.

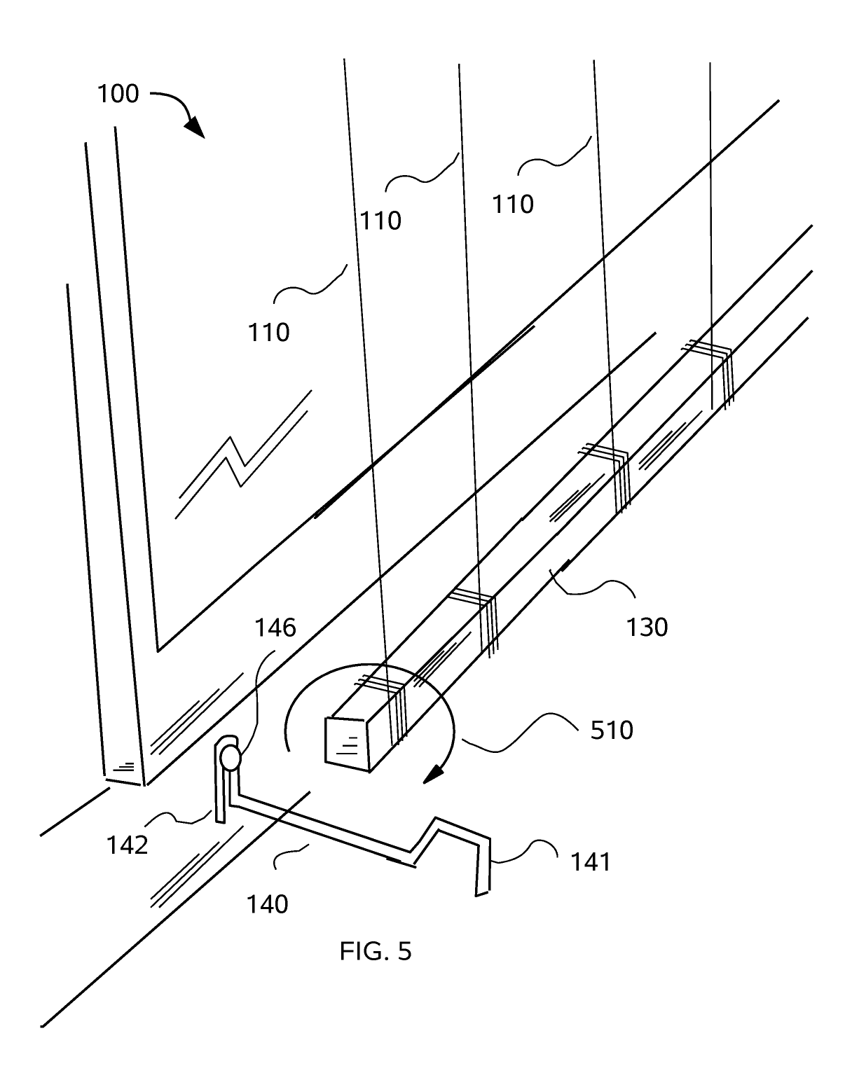

More preferably, the brackets 140 of this types is formed of a single length of stiff metal coil that is bent to form the shaft receiving end 141 and a wall mounting end 142, which may be best appreciated from the perspective view thereof in FIGS. 4 and 5. The wall mounting end 142 has a penetration 145 and can be any shape to receive the shoulder of a fastener, such as a nail or bolt 146, but is easily formed to have a U shaped end 142 as shown in FIG. 2B. The nail or bold 145 is secured to the building structure 10, or a part or extension thereto.

As shown in FIG. 2A, the upper and lower brackets 140 and 140′, can have the same shape, but the lower bracket 140′ is inverted to resist the tension in the wires pulling up on the lower rod 130.

Moreover, the lower rod in its most extended position 130′, as shown in FIG. 1, can be rolled upwards, or downwards indicated by the arrow 501 in FIG.

5B whereby the strings 110 achieve a desired apparatus length as shown, for example, in the position of 130 in FIG. 1. Thus a pair or rods 120 and 130 when attached to each other by evenly spaced connecting wires 110 can be unraveled to the height of a window, and/or cut to also match the width of a window.

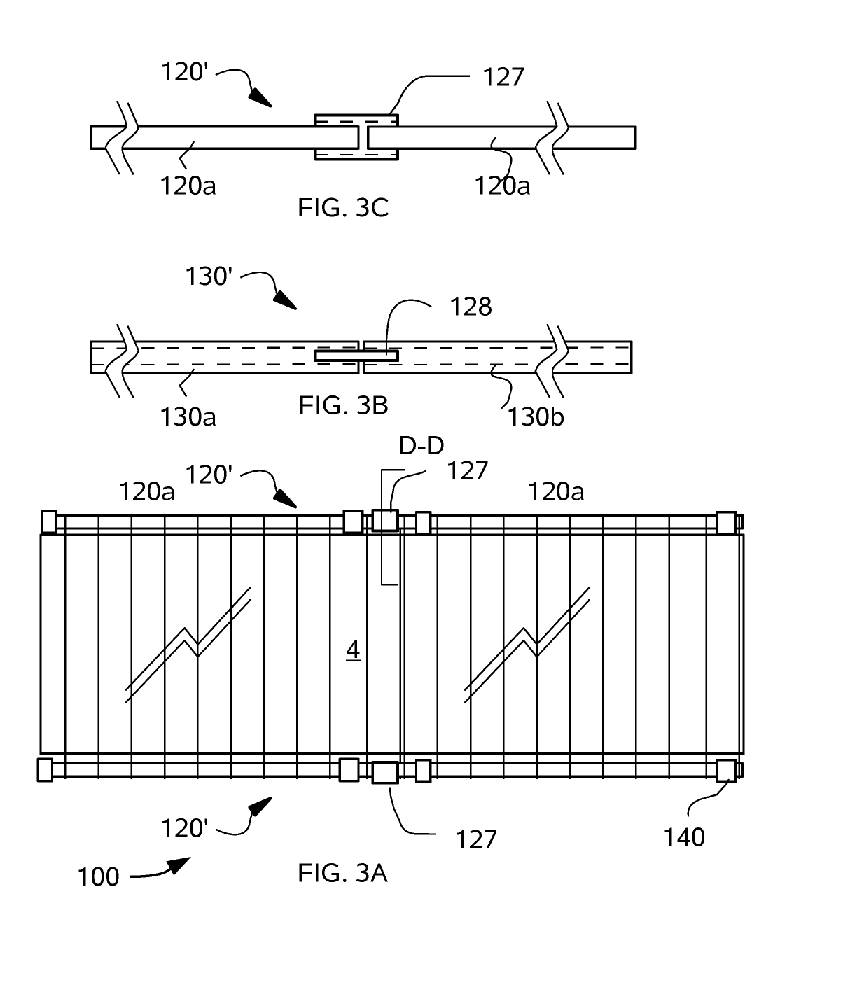

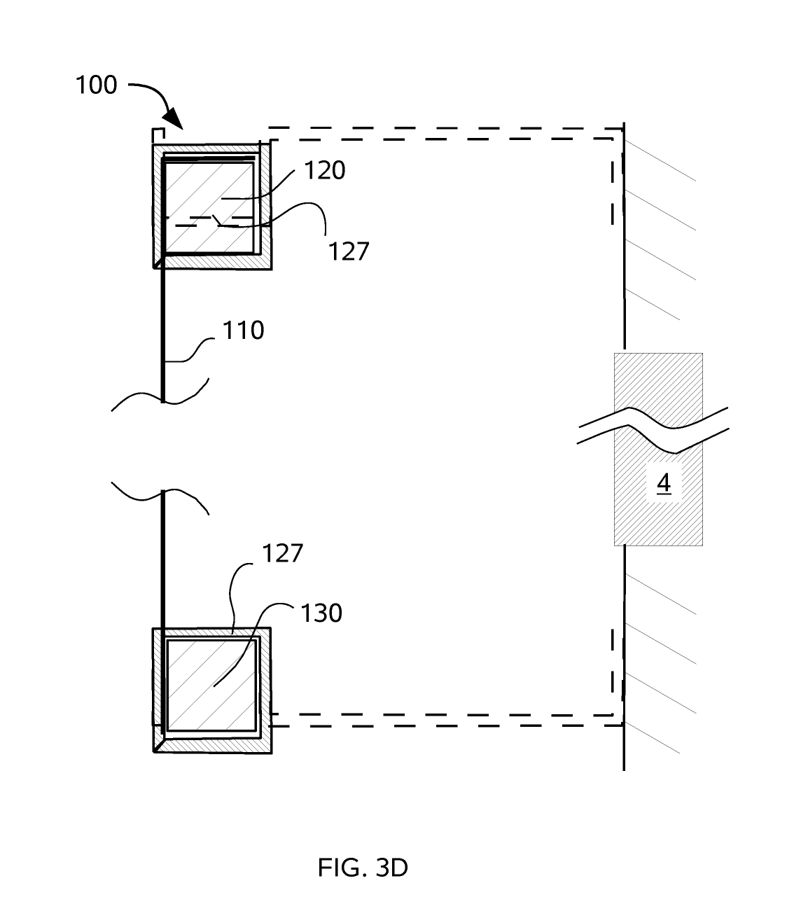

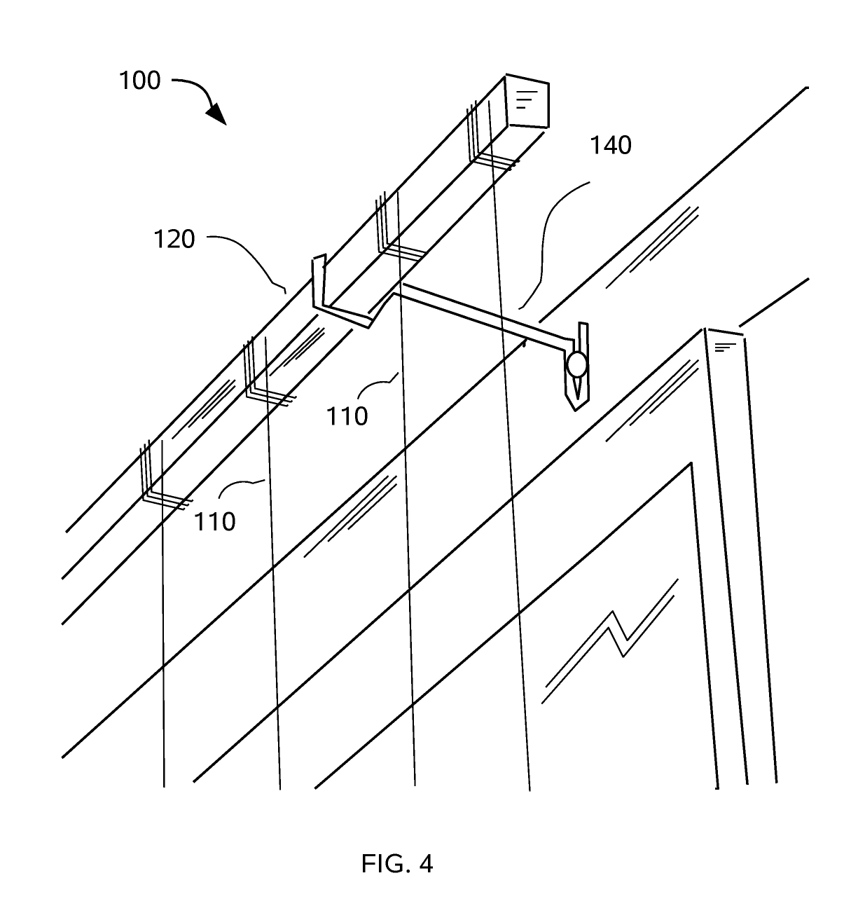

Moreover, in order to cover a window width that exceeds that of a given width of the of the single pair of the upper and lower rods 120 and 130, as shown in FIG. 3C, two or more pairs of upper and lower rods 120 and 130 having the attached wires 110 can be joined together side by side by means of an outer coupling or sleeve 127, or if the rods 120a and 120b or 130a and 130b comprise tubes, by means of inserting an internal connector 128 into the adjoining ends of the apparatuses.

It should now be appreciated that an important aspect of the instant invention is that it is an effective as a kit or out-of-the-box device that can be installed over a wide size-range of windows with little or no on-site modification. It can be easily mounted by an unskilled person, and it can be easily removed and replaced for window cleaning or other reason. Using fine line strings as wires 120, it obscures less than one percent of a window viewing area. Moreover, it incorporates a minimum of components, and stores and ships in a compact unit.

Accordingly, another aspect of the invention is a kit for installing the apparatus on windows that comprises at least of pair of rods 120 and 130 that are connected by a plurality of spaced apart strings or wires. Preferably, the rods are at least 3 to 6 feet long, and have the strings spaced 2″ to 8″ apart, either connect directly two each rod or via a spring 125, and wound in place around at least one of the rods. More preferably, the kit includes another such pair of connected rods and a pair of end couplers, such as 127 or 128. Most preferably, any such kit also includes at least two pairs of brackets 140 that can preclude rotation of at least one rod that are at least about 4 to 5″ long to place the strings 110 at least about 5″ from a window 4.

FIG. 5 demonstrates a method by which the height of the apparatus 100 is shortened or lengthened, that is, by rolling one of the horizontal rods toward the other and spooling the strings with it.

Experimental Tests

The effectiveness of various embodiments of the invention was tested on two side-by- side house windows. Each window measured 7 feet wide by 5 feet high. These faced a large garden area containing numerous bird feeders. During daylight hours the garden was (and still is) typically populated by dozens of birds, including a variety of sparrows, goldfinches, house finches, nuthatches, black phoebes, chickadees, California quail, robins, titmouses, western bluebirds, spotted towhees, California towhees, juncos, vireos, mourning doves, scrub jays, steller's jays, nuttall's woodpeckers, downy woodpeckers, acorn woodpeckers, various hummingbirds and seasonally, swallows, grosbeaks, orioles, cedar waxwings, and tanagers. Occasionally the garden is visited by merlins, and red-tailed hawks.

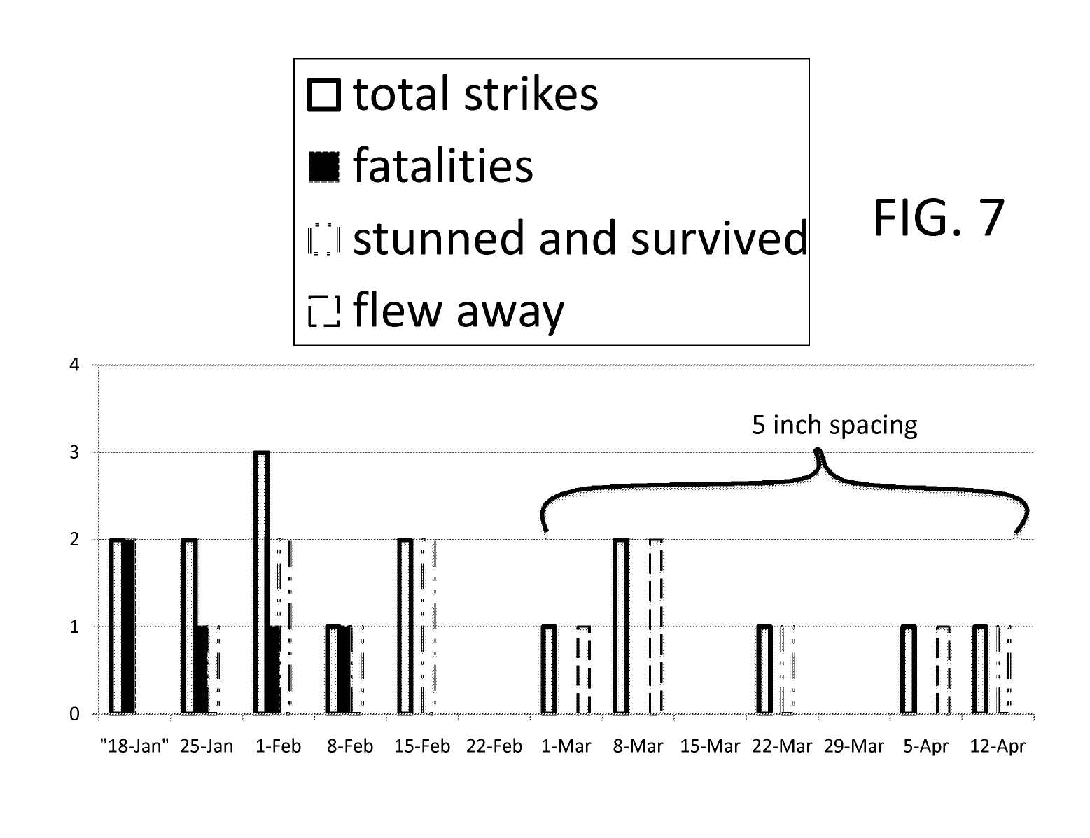

The device was tested over a three month period starting in early January, as reflected in the X-axis of the bar graph of the results in FIG. 7. The device that is the subject of this invention was first installed on the above windows. For a period of at least three years prior to the installation these same windows had been frequently struck by birds. Though no log was kept during that prior time, the inventor can attest that in an average week in that period three birds would strike the windows and die as a result thereof and that additional birds struck the windows and survived.

The device was initially mounted on the exterior of said windows leaving a space between the vertical strings and the glass which they paralleled of only one inch. Subsequently a log of bird strikes was kept, and is plotted in FIG. 7 (Note: Some strikes, especially the flyaway types, may not have been observed and recorded. However, bird strike fatalities were always noted and recorded because the bird carcasses remained as evidence.) FIG. 7 illustrates that the apparatus described herein, when optimally configured as described herein and equipped with strings of plastic fishing line, very effective in preventing birds from crashing into glass: The number of bird window crashes fell from the previous 1 or 2 a week to only 1 in six months.

Surprising, the last half of the roughly 4 month long experiments when the spacing was varied up to about 5″ (as marked on FIG. 7 starting at the week labeled “1-March”) no birds were found dead or permanently injured outside the window used for testing. In the previous months of testing when the spacing was 1 inch, and even 2″, one or two dead birds were found each week.

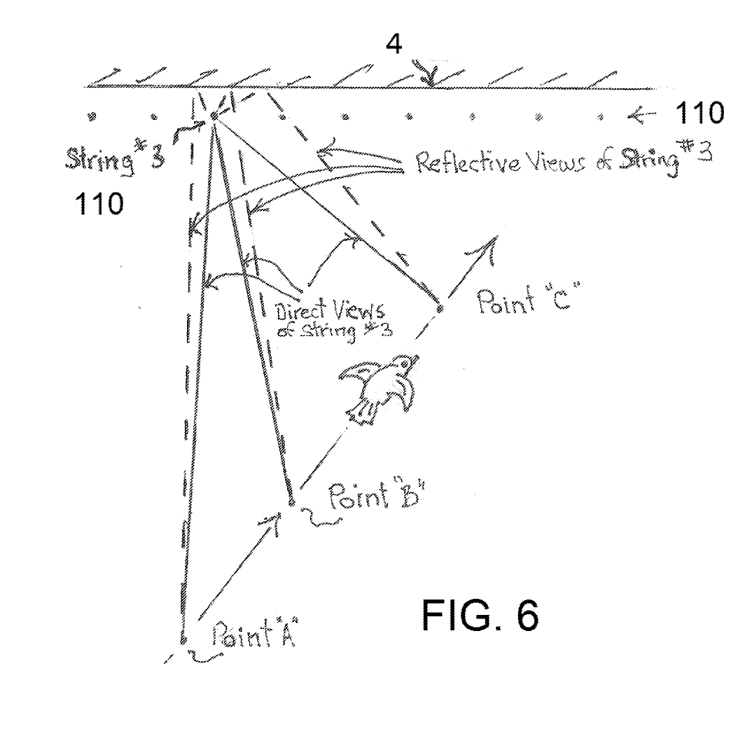

Not wishing to be bound by theory, it is now believed that the unexpected benefit of a 5″ spacing occurs because birds are more likely to perceive the wire 110 when they are about 5″ from the window as they sense or perceive the relative motion of the reflection of the wires from the windows surface. By simple geometric principles illustrated in FIG. 6, it has now been deduced that the change in the position of the wires reflection is more dramatic when the wires 110 are about 5″ from the window, which I have termed Parallel Line Reflective Motion (PLRM). The function of PLRM has to do with the proximity of the strings to a reflective glass surface. Recall that when we installed the device that is the subject of this invention in very close proximity to a glass window, (the strings were placed parallel to the glass with a space of approximately one inch between the glass and the strings), the reduction of bird strikes was minimal. However, when we then installed the device outward from the glass, leaving a space of approximately five inches between the glass and the strings, the reduction of bird strikes increased dramatically.

When the strings are installed directly on or very close to the glass, the scenario as seen by an approaching bird in flight is relatively static. The bird may or may not focus on the strings. However, by placing the strings parallel to but outward from the plane of the glass so as to leave a greater distance between the strings and the glass a dynamic comes into play. This dynamic comprises the perception by a bird flying in front of the string-covered reflecting glass of convergence and divergence between the strings and their reflections off of the glass. This dynamic is sensed by a bird as motion. Motion, in turn, alerts the bird to danger and instinctively causes the bird to change its flight path.

PLRM becomes more pronounced with the increase in angle of a bird's flight path to the plane of a glass surface. FIG. 6 is a sky view of a bird flying toward a reflective glass. It isolates the bird's view of a single string, viz., String #3 (110), so as to demonstrate the changing relative angles formed between the direct views and the reflective views of the string as the bird proceed from Point “A” to Points “B” and “C.” In reality, a bird flying in front of a window equipped with the device would see all of the strings and the perceived movement would be compounded. However, PLMB comes into play even in the instance when a bird's flight path is 90 degrees to the window). This is likely so because birds have a much finer sense of motion than humans. For example, a bird can detect motion of a slow moving object on the horizon that humans cannot sense. Thus, birds can observe the convergence or divergence of even a fraction of a degree.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

I claim:

1) An apparatus for repelling birds from windows, the apparatus comprising:
a) a first elongated shaft,
b) a second elongated shaft disposed parallel and below said first elongated shaft, each of the first and second elongated shafts having two ends disposed at the opposite side of the principal axis thereof,
c) at least a first pair of two laterally disposed brackets having a shaft receiving end and a wall mounting end, wherein each of the brackets in said pair are disposed for supporting at least one of said first and second elongated shafts on the shaft receiving end near the opposing ends thereof with each bracket being disposed perpendicular the principal axis of said elongated shaft supported thereon,
d) a plurality of flexible wires connected to and spaced apart along each of the first and second elongated shafts in which each of the wires in said plurality is capable of extending outward from the first elongated shaft to the second elongated shaft to form an array of parallel spaced wires,
e) wherein the brackets have a length perpendicular to the elongated shaft supported therein of at least about 1 inches to provide a capability for spacing the array of parallel spaced wires away from a window when the brackets are mounted at the side of a window so that said elongated shafts are disposed parallel to the side of the window.

2) An apparatus for repelling birds from windows according to claim 1 wherein the brackets have a length perpendicular to the elongated shaft supported therein of not more than about 5 inches to provide a capability for spacing the array of parallel spaced wires away from a window when the brackets are mounted at the side of a window so that said elongated shafts are disposed parallel to the side of the window.

3) An apparatus for repelling birds from windows according to claim 1 further comprising:
a) a second pair of two laterally disposed brackets having a shaft receiving end and a wall mounting end, wherein each of the brackets in said pair are disposed for supporting at least the other of the first and second elongated shafts on the shaft receiving end near the opposing ends thereof with each bracket being disposed perpendicular the principal axis of said elongated shaft supported thereon,

4) An apparatus for repelling birds from windows according to claim 1 wherein at least one of the first and second elongated shafts have a square cross-section perpendicular to the principal axis thereof and each of the brackets has a square pocket that is open on at least one side is of substantially complimentary dimensions to the cross-section of the elongated shaft to receive the elongated shafts supported herein to prevent the rotation thereof.

5) An apparatus for repelling birds from windows according to claim 3 wherein the elongated shafts have a square cross-section perpendicular to the principal axis thereof and each of the brackets has a square pocket that is open on at least one side is of substantially complimentary dimensions to the cross-section of the elongated shaft to receive the elongated shafts supported herein to prevent the rotation thereof.

6) An apparatus for repelling birds from windows according to claim 5 wherein the open side of the upper bracket is pointed in a first direction and the lower side of the lower bracket is pointed in a direction opposite the first direction.

7) An apparatus for repelling birds from windows according to claim 5 wherein the open side of the upper bracket is pointed upward.

8) An apparatus for repelling birds from windows according to claim 1 wherein the plurality of wires that connect to the first and second elongated shafts are wound around at least one of the first and second shaft perpendicular to the principal axis thereof.

9) An apparatus for repelling birds from windows according to claim 1 wherein at least one of the elongated shafts comprises 2 or more monolithic shafts and are joined by a coupling that extends over the ends of the 2 laterally adjacent monolithic shafts.

10) An apparatus for repelling birds from windows according to claim 1 wherein at least one of the elongated shafts comprises 2 or more monolithic shafts each having a hollow core and are joined by a internal coupling that extends within the hollow cores of the 2 laterally adjacent monolithic shafts.

11) An apparatus for repelling birds from windows, the apparatus comprising:
a) a first elongated shaft,
b) a second elongated shaft disposed parallel and below said first elongated shaft, each of the first and second elongated shafts having two ends disposed at the opposite side of the principal axis thereof,
c) at least a first pair of two brackets having a shaft receiving end and a wall mounting end, wherein each of brackets in said pair are disposed for supporting at least one of said first and elongated shafts on the shaft receiving end near the opposing ends thereof with each bracket being disposed perpendicular the principal axis of said elongated shaft supported thereon,
d) a plurality of wires connected to and spaced apart along each of the first and second elongated shafts in which each of the wires in said plurality extends outward from the first elongated shaft to the second elongated shaft to form a an array of parallel spaced apart wires,
e) wherein the plurality of wires that connect to said first and second elongated shafts are wound around at least one of said first and second shaft perpendicular to the principal axis thereof.

12) An apparatus for repelling birds from windows according to claim 11 wherein at least one of the first and second elongated shafts comprises 2 or more monolithic shafts are joined by a sleeve that extends over the ends of the 2 laterally adjacent monolithic shafts.

13) An apparatus for repelling birds from windows according to claim 11 wherein at least one of the elongated shafts comprises 2 or more monolithic shafts each having a hollow core and are joined by a internal coupling that extends within the hollow cores of the 2 laterally adjacent monolithic shafts.

14) An apparatus for repelling birds from windows according to claim 11 further comprising a second pair of two brackets having a shaft receiving end and a wall mounting end, wherein each of brackets in said pair are disposed for supporting the other one of said first and elongated shafts on the shaft receiving end near the opposing ends thereof with each bracket being disposed perpendicular the principal axis of said elongated shaft supported thereon.

15) An apparatus for repelling birds from windows according to claim 11 wherein at least one of the first and second elongated shafts have a square cross-section perpendicular to the principal axis thereof and each of the brackets in said pair has a square pocket that is open on at least one side and of complimentary dimensions to the cross-section of the elongated shafts to receive and support the elongated shafts therein to prevent the rotation thereof.

16) An apparatus for repelling birds from windows according to claim 14 wherein the first and second elongated shafts have a square cross-section perpendicular to the principal axis thereof and each of the brackets has a square pocket that is open on at least one side and of complimentary dimensions to the cross-section of the elongated shafts to receive and support the elongated shafts therein to prevent the rotation thereof.

17) An apparatus for repelling birds from windows according to claim 16 wherein the open side of the upper bracket is pointed in a first direction and the lower side of the lower bracket is pointed in a direction opposite the first direction.

18) A building comprising:
a) a least one lateral wall having an aperture therein,
b) a transparent window disposed to cover said aperture in the lateral wall,
c) a first elongated shaft,
d) a second elongated shaft disposed parallel and below said first elongated shaft, each of said first and second elongated shafts having two ends disposed at the opposite side of the principal axis thereof,
e) at least a first pair of two laterally disposed brackets having a shaft receiving end and a wall mounting end, wherein each of the brackets in said pair are disposed for supporting said first an elongated shafts on the shaft receiving end near the opposing ends thereof with each bracket being disposed perpendicular the principal axis of said first elongated shaft,
f) a plurality of wires connected to and spaced apart along each of the first and second elongated shafts in which each of the wires in said plurality extends downward from the said elongated shaft to said second elongated shaft to form a vertical wire array,
g) wherein the upper brackets are mounted at the wall mounting end to the portion of the wall above the aperture therein.

19) A building according to claim 18 wherein the plurality of wires that connect to the first and second elongated shafts are wound around at least one of the first and second shaft perpendicular to the principal axis thereof.

20) A building according to claim 19 wherein the brackets have a length perpendicular to the elongated shaft to dispose the vertical wire array at least between about 1 to 5 inches away from the window.

21) A kit for installing a bird strike protective apparatus over windows, the kit comprising:
a) a first elongated shaft,
b) a second elongated shaft,
c) a plurality of wires connected to and spaced apart along each of the first and second elongated shafts in which each of the wires in said plurality is capable of extending outward from the first elongated shaft to the second elongated shaft to form an array of parallel spaced apart wire,
d) wherein the plurality of wires that connect to the first and second elongated shafts are wound around at least one of the first and second shaft perpendicular to the principal axis thereof substantially at the point of attachment thereto so as to permit the spacing apart of the shafts by rotating at least one shaft to uncoil all the wires in said plurality simultaneously.

22) A kit for installing a bird strike protective apparatus over windows wherein the ends of the wires in said plurality are wound around the first or the second shaft and are coupled to the other of the said first and second elongated shaft by springs to regulate the tension thereon.
